(19) United States
(12) Patent Application Publication
(10) Pub. No.: US 2008/0296383 A1
(43) Pub. Date: Dec. 4, 2008

(54) Range finding in imaging readers for electro-optically reading indicia

(76) Inventors: Vladimir Gurevich, Stony Brook, NY (US); Edward Barkan, Miller Place, NY (US)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/807,943

(22) Filed: May 30, 2007

(51) Int. Cl. G06K 7/10

(52) U.S. Cl. 235/462.21

(57) ABSTRACT

In an imaging reader for reading a target located in a range of working distances from the reader, a solid-state imager captures light from the target, and an optical assembly visually illuminates the target to aid an operator in aiming the imager at the target, and also visually indicates to the operator the range of working distances from the imager to the target.

### BACKGROUND OF THE INVENTION

1. Field of the Invention

The present invention generally relates to imager-based readers for electro-optically reading indicia and, more particularly, to generating on the indicia visible light patterns indicative of a field of view and a depth of field of an imager operative for capturing light returning from the indicia.

2. Description of the Related Art

Optical codes or dataforms are patterns made up of image areas having different light-reflective or light-emissive properties, which are typically assembled in accordance with a priori rules. The optical properties and patterns of codes are selected to distinguish them in appearance from the background environments in which they are used. Electro-optical readers identify or extract data from codes and are used in both fixed or portable installations in many diverse environments such as in stores for check-out services, in manufacturing locations for work flow and inventory control, and in transport vehicles for tracking package handling. The code is used as a rapid, generalized means of data entry.

Many conventional readers are designed to read one-dimensional bar code symbols. The bar code symbol is a pattern of variable-width rectangular bars separated by fixed or variable width spaces. The bars and spaces have different light-reflecting characteristics. One example of a one-dimensional bar code symbol is the UPC/EAN code used to identify, for example, product inventory. An example of a two-dimensional or stacked bar code symbol is the PDF417 barcode, which is disclosed in U.S. Pat. No. 5,635,697. Another conventional code is known as “MaxiCode”, which consists of a central finder or bull's eye center and a grid of hexagons surrounding the central finder. It should be noted that the aspects of the inventions disclosed in this patent application are applicable to optical code readers, in general, without regard to the particular type of optical codes that they are adapted to read.

Many conventional readers are hand-held and generate one or more moving beams of laser light that sweep one or more scan lines across a symbol that is located anywhere in a range of working distances from a reader. The reader obtains a continuous analog waveform corresponding to the light reflected or scattered from the symbol. The reader then decodes the waveform to extract information from the symbol. A reader of this general type is disclosed, for example, in U.S. Pat. No. 4,251,798. A reader for detecting and decoding one-and two-dimensional symbols is disclosed in U.S. Pat. No. 5,561,283.

Symbols can also be read by employing solid-state imagers in imaging readers, also often deployed in hand-held housings. For example, an imager, akin to that used in a digital camera, may have a one- or two-dimensional array of cells or pixel sensors that correspond to image elements or pixels in a field of view of the imager. Such an imager may be a one- or two-dimensional charge coupled device (CCD) or a complementary metal oxide semiconductor (CMOS) device, and associated circuits for producing electronic signals corresponding to the one- or two-dimensional array of pixel information over the field of view.

It is therefore known to use a CCD for capturing a monochrome image of a bar code symbol to be read as, for example, disclosed in U.S. Pat. No. 5,703,349. It is also known to use a CCD with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

Although generally satisfactory for its intended purpose, the use of an imaging reader is frustrated because an operator cannot tell whether the imager, or the hand-held housing in which the imager is mounted, is aimed directly at the target symbol, which can be located anywhere within a range of working distances from the reader. Contrary to moving laser beam readers in which an operator can see the visible laser beam as at least one scan line on the symbol, the imager is a passive unit and provides no visual feedback to the operator to advise where the imager is aimed.

To alleviate such problems, the prior art proposed in U.S. Pat. No. 6,060,722 an aiming light pattern generator for an imaging reader. This known generator utilizes a diffractive element, a holographic element, or a Fresnel element, which generates a light interference pattern useful for framing the field of view. It is also known to use non-interferometric optical elements to project an aiming line as described in U.S. Pat. No. 6,069,748, which disclosed the use of a toroidal lens to project a single aiming line to guide a cutting tool. U.S. Pat. No. 7,182,260 disclosed the use of an optical element having a plurality of refractive structures to generate a light pattern on a symbol for framing the field of view of an imager.

However, the known light pattern generators produce patterns that are not well visible in high ambient light conditions, such as bright sunlight. Also, the known patterns do not indicate the working distance range (depth of field) of the imager, or the optimum distance in the working range in which a symbol should be read for optimal reading performance. To determine the distance between an imager and a symbol, the prior art, as shown in FIG. 3, determines the parallax between an imaging axis and an aiming light axis.

More particularly, FIG. 3 shows an imaging lens 1 having an imaging axis 7 and operative for imaging a target 3 on a multiple sensor imager 2. An aiming pattern generator 5 having an aiming light axis 6 creates an aiming pattern 4 on the target 3 consisting of a central cross 4a and framing lines 4b-4e showing approximately the corners of the field of view of the imager 2. There is a parallax “s” between axes 6 and 7 of the aiming generator 5 and the imaging lens 1. When a working distance “Z” of the target 3 changes, an image 4a′ of the central cross 4a shifts from the optical axis 7 by s′=2*F/Z where “F” is the focal length of the lens 1. From this equation, the working distance Z can be evaluated if the shift s' is known. System calibration is required to know which sensor of the imager 2 is located on the imaging axis 7 of the lens 1. However, this approach requires each reader to be calibrated since the location of a central sensor in the imager 2 varies widely from one reader to the next.

### SUMMARY OF THE INVENTION

One feature of the present invention resides, briefly stated, in an arrangement for use with an imaging reader for, and a method of, reading a target, such as one-dimensional or two-dimensional bar code symbols, located in a range of working distances from the reader. The arrangement includes a solid-state imager including an array of image sensors for capturing light from the target in the range of working distances over a field of view. Such an imager may be a one- or two-dimensional charge coupled device (CCD) or a complementary metal oxide semiconductor (CMOS) device.

In accordance with one feature of this invention, an optical assembly is provided for visually illuminating the target to aid an operator in aiming the imager at the target, and for visually indicating to the operator the range of working distances from the imager to the target. Thus, the optical assembly indicates the working distance range (depth of field) of the imager, as well as the optimum distance in the working range in which the target should be read for optimal reading performance.

In the preferred embodiment, the optical assembly includes a pair of aiming pattern generators for producing on the target a pair of visible light patterns that assume predetermined positional relationships indicative of the range of working distances. The light patterns include respective light spots that overlap each other at an optimum working distance in the range, and that are spaced apart at a working distance other than the optimum working distance in the range. The light spots have a predetermined orientation at a working distance less than the optimum working distance in the range, and the light spots have a reverse orientation opposite to the predetermined orientation at a working distance greater than the optimum working distance in the range.

In addition, a predetermined number of the light spots is visible at the optimum working distance in the range, and a different number of the light spots is visible at a working distance other than the optimum working distance in the range.

Each aiming pattern generator may produce a single light spot, or a plurality of light spots. The aiming pattern generators are preferably successively activated to produce the light patterns in succession.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from targets;

FIG. 2 is a schematic block diagram of various components of an imaging reader used in the workstation of FIG. 1 in accordance with the present invention;

FIG. 3 is a diagrammatic perspective view of an aiming light arrangement used in an imaging reader for generating an aiming light pattern on a target in accordance with the prior art;

FIG. 4 is a diagrammatic perspective view analogous to FIG. 3 of one embodiment of the arrangement in accordance with the present invention;

FIG. 5 is a diagrammatic top plan view of the arrangement of FIG. 4;

FIG. 6 is a set of three light patterns generated by the arrangement of FIG. 4; and

FIG. 7 is a diagrammatic top plan view analogous to FIG. 5 of another embodiment of this invention.

### DETAILED DESCRIPTION OF THE PREFERRED EMBODIMENTS

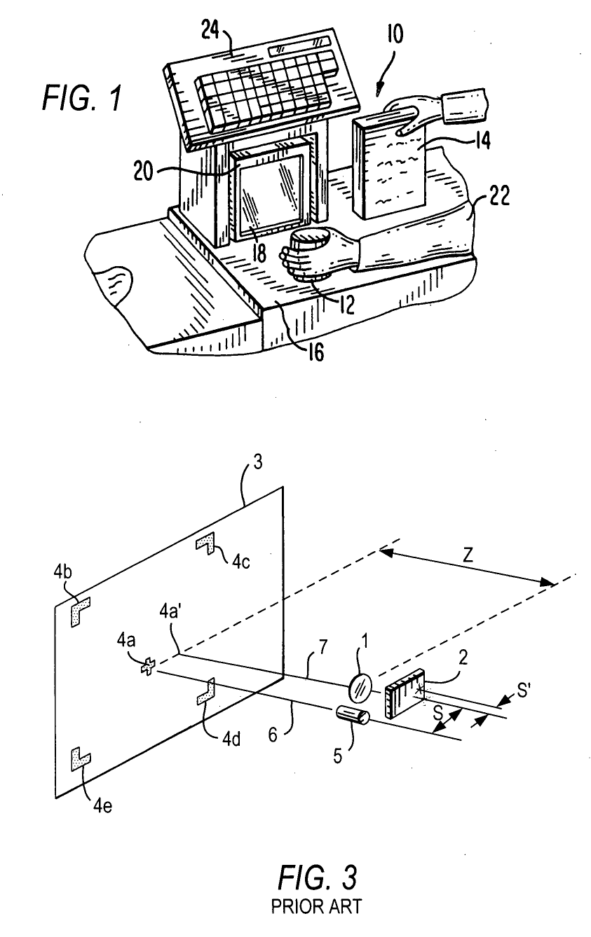

Reference numeral 10 in FIG. 1 generally identifies a workstation for processing transactions and specifically a checkout counter at a retail site at which products, such as a can 12 or a box 14, each bearing a target symbol, are processed for purchase. The counter includes a generally planar support surface or countertop 16 across which the products are slid at a swipe speed past a generally vertical window 18 of a box-shaped, vertical slot, portable imaging reader 20 mounted on the countertop 16 in a hands-free mode of operation. A checkout clerk or operator 22 is located at one side of the countertop, and the imaging reader 20 is located at the opposite side. A cash/credit register 24 is located within easy reach of the operator. In the frequent event that large, heavy, or bulky products, that cannot easily be brought to the reader 20, have target symbols that are required to be read, then the operator 22 may also manually grasp the portable reader 20 and lift it off, and remove it from, the countertop 16 for reading the target symbols in a hand-held mode of operation. The reader need not be box-shaped as illustrated, but could have virtually any housing configuration, such as a gun shape.

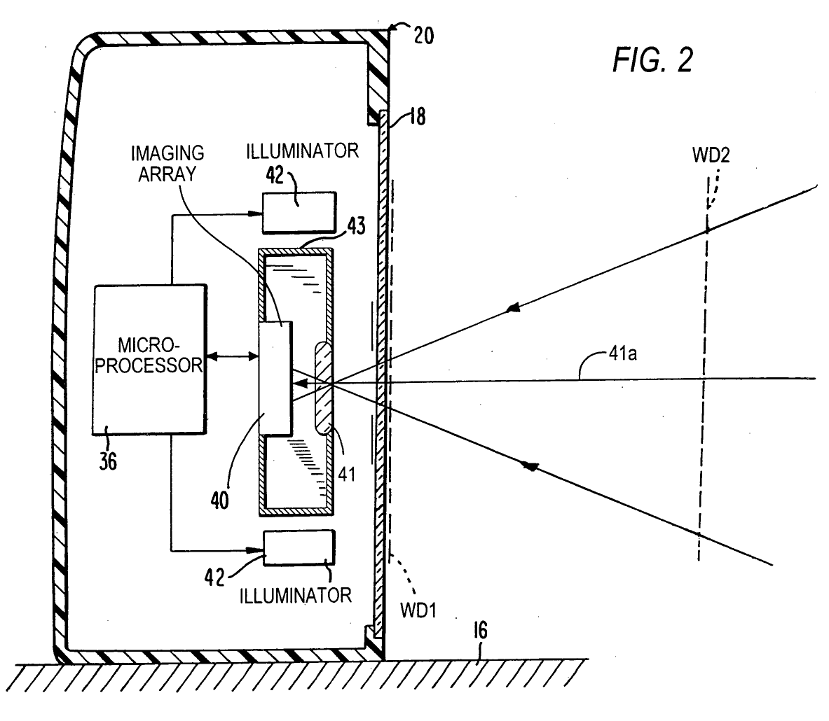

As shown in FIG. 2, the portable imaging reader 20 includes an imager 40 and a focusing lens 41 mounted in an enclosure 43. The imager or imaging array 40 is a solid-state device, for example, a CCD or a CMOS imager and has a one- or two-dimensional array of addressable image sensors operative for capturing return light through the window 18 from a target, e.g., a one-dimensional symbol, a two-dimensional symbol, a document, a person, etc., over a field of view and located anywhere in a working range of distances between a close-in working distance (WD1) and a far-out working distance (WD2). The focusing lens 41 focuses the return light onto the imager and has an imaging axis 41a. Typically, WD1 is about two inches from the imager 40 and generally coincides with the window 18, and WD2 is about eight inches from the window 18. A suitable imager is disclosed in U.S. Pat. No. 5,965,875. An illuminator 42 is also mounted in the reader and preferably includes a plurality of light sources, e.g., light emitting diodes (LEDs) arranged around the imager 40 to uniformly illuminate the target.

As also shown in FIG. 2, the imager 40 and the illuminator 42 are operatively connected to a controller or microprocessor 36 operative for controlling the operation of these components. Preferably, the microprocessor is the same as the one used for decoding light scattered from the target symbol and for processing the captured target images.

In operation, the microprocessor 36 sends a command signal to the illuminator 42 to pulse the LEDs for a short time period of 500 microseconds or less, and energizes the imager 40 to collect light from a target substantially only during said time period. A typical array needs about 33 milliseconds to read the entire target image and operates at a frame rate of about 30 frames per second. The array may have on the order of one million addressable image sensors.

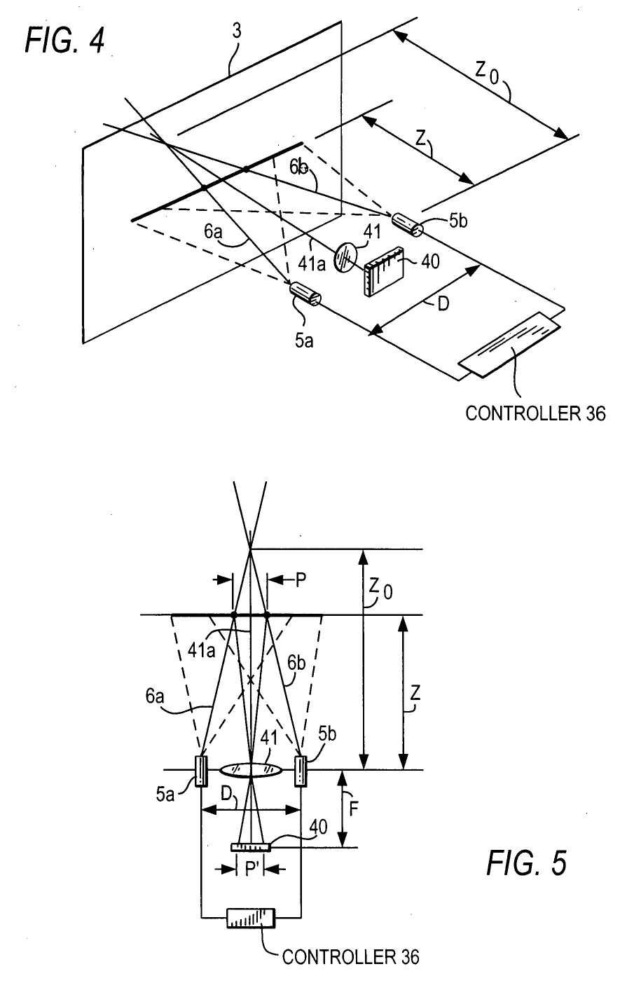

FIGS. 4-6 show a first embodiment of the reader 20 with a preferred aiming/ranging composite pattern. There are two aiming pattern generators 5a and 5b controlled by the controller 36 and spaced apart by a distance “D” from each other and at opposite sides of the imager 40 and the focusing lens 41. The imager 40 and the focusing lens 41 are spaced apart by the focal length F. Each generator 5a and 5b has an aiming axis 6a and 6b, respectively, and produces an aiming pattern that includes a bright spot on the aiming axis 6a, 6b and generally located in the middle of a horizontal line indicating a width of the imaging field of view. The aiming axes 6a and 6b intersect at a working distance Zo corresponding to the optimum imaging plane to image a target 3, for example, for document capture or driver license PDF bar-code reading.

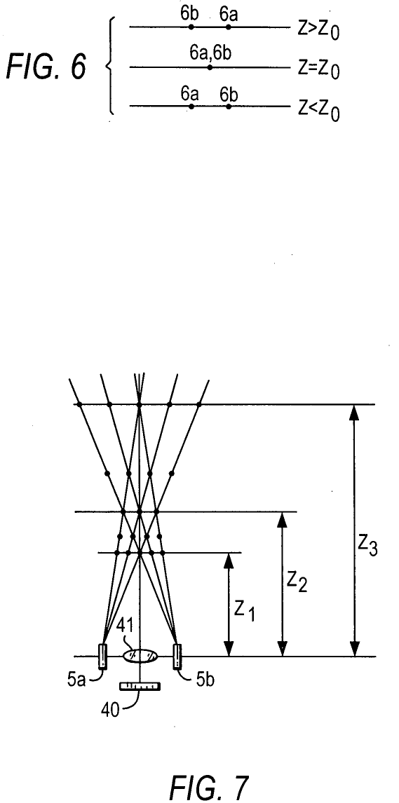

The resulting composite pattern produced by the aiming pattern generators 5a and 5b changes with the working distance Z as shown in FIG. 6. When the target is located at the optimum imaging plane (Z=Zo), the two bright spots overlap, and the user sees a single composite spot on the horizontal line and knows that the target is in the optimum imaging plane. When the target is located either between the optimum imaging plane and the reader (Z<Zo), or beyond the optimum imaging plane away from the reader (Z>Zo), then the bright spots are separated by a distance P, thereby advising the user of the range of working distances. The spot separation P is proportional to the distance from the optimum imaging plane, and can be expressed by the following equation:

P=abs(Z−Zo)*D/Zo

The images of the two bright spots are separated on the imager 40 by a distance P′, and can be expressed by the following equation:

P′=P*F/Z=abs(Z−Zo)*D*F/(Zo*Z)=D*F*abs(1/Zo−1/Z).

The working distance Z to the target 3 can be then determined based on the distance P′ by the following equation:

Z=(±D*F/P′−1/Zo)̂(−1)

The separation of the two spots P and their images P′ alone does not allow determining if the target is closer to or further from the optimum imaging plane Zo. However, the direction of the target shift from the optimum imaging plane Zo can be determined by alternatively switching on and off the two aiming pattern generators 5a and 5b. The alternate illumination of the bright spots makes clear which of the generators formed the spot on the left of the imaging axis 41a and which formed the spot on right of the imaging axis 41a as shown in FIG. 6.

The distance D between the two aiming pattern generators 5a, 5b should be chosen small enough so that both bright spots are always located on the target. For example, if D=5 mm, and if Zo=12 inches, then the spot separation of target does not exceed 5 mm anywhere up to Z=48 inches.

The reader of FIGS. 4-6 has the following advantages: The distance to a target can be determined without individual system calibration since the parameters D, F, and Zo are provided by design and known in advance. In some cases, it is only important to know if the target is closer to or further from the optimum imaging plane Zo, which can be quickly determined based on the timing between the illumination of the spots on axes 6a and 6b. The bright spots on axes 6a, 6b will be well visible even at high ambient light conditions. The user has visual guidance as to where to put the target within the range of working distances to obtain the best image capture.

It might be also desirable to mark more than one imaging plane, for example, the beginning and the end of the working distance range. In this case, the aiming pattern generators 5a, 5b each can generate more than one bright spot. FIG. 7 shows the case when each aiming pattern generator generate three bright spots. One of the spots from generator 5a overlaps one of the spots from generator 5b on the target at three working distances Z1, Z2, Z3. When the target is closer than Z1, then all the spots from generator 5b are on the right, and all the spots from generator 5a are on the left. When the target is further than Z3, then all the spots from generator 5a are on the right, and all the spots from generator 5b are on the left. The composite aiming/ranging pattern also provides a bright central spot at the far distance Z3 even if other of the spots already fall off the target.

In case the imager is a CMOS array with a rolling shutter, then it is necessary to take two images, one for each of the alternating spots. Only a central sensor of the CMOS array can be used to accelerate the process. In case the imager is a CCD array with a global shutter, then it is sufficient to take only a single image.

The working distance information can be used in many different ways to improve date capture efficiency and user feedback. For examples, a multi-focus or auto-focus system can be guided to the best focal position at the optimum working distance. Also, the illuminator 42 can be turned on only when the target is within the depth of field, thereby reducing power consumption and providing good feedback to the user. In addition, the brightness of the illuminator 42 can be controlled proportionately to the working distance to the target to further reduce power consumption. A visual or audio signal can be generated when the target is at a specific working distance. Signal processing over an extended range fixed-focus system can be optimized according to a known optical response vs. working distance.

Each aiming light pattern generator includes a light source, especially a laser, and utilizes an interferometric optical element, such as a diffractive element, a holographic element, or a Fresnel element, or a non-interferometric optical element, such as a lens, or an optical element having a plurality of refractive structures.

It will be understood that each of the elements described above, or two or more together, also may find a useful application in other types of constructions differing from the types described above.

While the invention has been illustrated and described as embodied in range finding in an imaging reader and method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. An arrangement for use with an imaging reader for reading a target located in a range of working distances from the reader, comprising:
a solid-state imager including an array of image sensors for capturing light from the target in the range of working distances over a field of view; and
an optical assembly for visually illuminating the target to aid an operator in aiming the imager at the target, and for visually indicating to the operator the range of working distances from the imager to the target.

2. The arrangement of claim 1, wherein the optical assembly includes a pair of aiming pattern generators for producing on the target a pair of visible light patterns that assume predetermined positional relationships indicative of the range of working distances.

3. The arrangement of claim 2, wherein the light patterns includes respective light spots that overlap each other at an optimum working distance in the range.

4. The arrangement of claim 3, wherein the light spots are spaced apart at a working distance other than the optimum working distance in the range.

5. The arrangement of claim 4, wherein the light spots have a predetermined orientation at a working distance less than the optimum working distance in the range, and wherein the light spots have a reverse orientation opposite to the predetermined orientation at a working distance greater than the optimum working distance in the range.

6. The arrangement of claim 3, wherein a predetermined number of the light spots is visible at the optimum working distance in the range, and wherein a different number of the light spots is visible at a working distance other than the optimum working distance in the range.

7. The arrangement of claim 2, wherein each aiming pattern generator produces a single light spot.

8. The arrangement of claim 2, wherein each aiming pattern generator produces a plurality of light spots.

9. The arrangement of claim 2, wherein the aiming pattern generators are successively activated to produce the light patterns in succession.

10. An arrangement for use with an imaging reader for reading a target located in a range of working distances from the reader, comprising:
means including an array of image sensors for capturing light from the target in the range of working distances over a field of view; and
means for visually illuminating the target to aid an operator in aiming the image sensors at the target, and for visually indicating to the operator the range of working distances from the image sensors to the target.

11. A method of reading a target located in a range of working distances from an imaging reader, comprising the steps of:
capturing light from the target in the range of working distances with a solid-state imager having an array of image sensors over a field of view; and
visually illuminating the target to aid an operator in aiming the imager at the target, and visually indicating to the operator the range of working distances from the imager to the target.

12. The method of claim 11, wherein the illuminating step is performed by producing on the target a pair of visible light patterns that assume predetermined positional relationships indicative of the range of working distances.

13. The method of claim 12, wherein the illuminating step is performed by overlapping light spots from the light patterns at an optimum working distance in the range.

14. The method of claim 13, wherein the illuminating step is performed by spacing the light spots apart at a working distance other than the optimum working distance in the range.

15. The method of claim 14, wherein the illuminating step is performed by orienting the light spots to have a predetermined orientation at a working distance less than the optimum working distance in the range, and by orienting the light spots to have a reverse orientation opposite to the predetermined orientation at a working distance greater than the optimum working distance in the range.

16. The method of claim 13, wherein the illuminating step is performed by generating a predetermined number of the light spots to be visible at the optimum working distance in the range, and by generating a different number of the light spots to be visible at a working distance other than the optimum working distance in the range.

17. The method of claim 12, and producing each pattern with a single light spot.

18. The method of claim 12, and producing each pattern with a plurality of light spots.

19. The method of claim 12, and successively producing the light patterns in succession.
